(19) United States
(12) Patent Application Publication
(10) Pub. No.: US 2012/0216663 A1
(43) Pub. Date: Aug. 30, 2012

(54) Cutting Unit For Labelling Machines

(76) Inventor: James Carmichael, Parma (IT)

(21) Appl. No.: 13/387,736

(22) PCT Filed: Feb. 5, 2010
(86) PCT No.: PCT/EP2010/051418

§ 371 Date: May 14, 2012

(30) Foreign Application Priority Data
Jul. 29, 2009 (IB) PCT/IB2009/053298

(51) Int. Cl. B26D 7/26; B26D 1/20

(52) U.S. Cl. 83/349; 83/679

(57) ABSTRACT

Cutting units for labelling machines, particularly of the type that use a label reel from which the labels are cut and applied on objects, such as containers, are provided.

In particular, the present invention provides cutting units for cutting labels from a label film in labelling machines, comprising a rotary blade drum and a stationary blade assembly, the said stationary blade assembly comprising a substantially U-shaped monolithic body having a movable portion, a fixed portion facing said movable portion and linked thereto by a linking portion, forming a U-shaped groove therebetween, wherein the movable portion of the monolithic body comprises an adjustable support for a blade, protruding from the end of the movable portion that is proximal to the linking portion, a projecting element defined by said adjustable support, the said blade being connected to said projecting element.

The present invention relates to a cutting unit for labelling machines, particularly of the type that use a label reel from which the labels are cut and applied on objects, namely on containers.

In these machines, generally known as roll fed labelling machines, the containers are carried by a carrousel and come into contact with a labelling unit. The labelling unit comprises a motorized path wherein at least one feeding roll moves the label strip from a label reel to the carrousel, a cutting unit, for cutting at the appropriate length the label from the label strip which is moved by the feeding roll, and a so called “vacuum drum” that receives the cut labels and finally transfers the labels to the objects (the containers or the mandrels in a sleeve-type labelling machine) in the carrousel.

The cutting unit comprises a rotary blade and a stationary blade, also known as the counterblade, that are positioned adjacent to the vacuum drum. The label film passes between the stationary and the rotary blade of the cutting unit while the film end is taken by suction by the vacuum drum. This latter rotates at a speed that is higher than the speed at which the label film is fed, thus the vacuum drum exerts a pulling force on the film end. When the rotary blade comes into contraposition with the stationary blade, the label film passing therebetween is cut. Typically, the stationary blade and the rotary blade contacts with substantially no interference, so that the label film, which is a thin plastic film, is weakened along the cutting line and the label is “torn” by the pulling force of the vacuum drum. The label length is determined by the speed at which the label film is fed, the faster the film the longer the label.

In order for the vacuum drum to firmly withdraw the label with good positional precision, it is essential that a substantial part of the label length, such as two-thirds of the label length, is retained by the vacuum drum. This problem may become particularly evident in the case of short labels, as the cutting may be made when only a minor part of the label is on the vacuum drum.

To overcome this problem, it has been proposed to dimension the cutting group-vacuum drum assembly so that the cutting of the label is made very close to the cutting group to vacuum drum tangent point or to the label transfer point. However, this arrangement can work only for a rotary blade drum of small diameter, the larger being the rotary blade drum, the longer being the label portion which is not retained by the vacuum drum. In practice, the encumbrance of the various parts constituting the cutting unit and the vacuum drum in this case forbids arranging the cutting point closer to the vacuum drum surface.

A rotary blade drum of small dimensions, containing only one blade, strongly limits the possibility to work with labels in a wide range of lengths. For this reasons, larger rotary blade drums containing two or more blades have been recently proposed. However, for these cutting units the above underlined problem of the too short label portion retained by the vacuum drum with respect to the not retained label portion is still unresolved.

It is therefore an object of the present invention to provide a cutting unit for a labelling machine that overcomes the above problem.

Moreover, it is known that the counter-blade in the stationary group may have some irregularities on the cutting surface which may create a slightly corrugated profile or it can not be perfectly straight. However, as the system work without substantial interference between counter-blade and rotary blade, it is essential that the counter-blade profile is finely adjusted to correct the said defects. The static blade must be precisely parallel to the rotary blade.

It is already known to provide a series of screws that directly act along the entire length of the counter-blade bar, on the surface thereof opposed to the cutting profile in order to correct the defects and make the cutting process effective. However, the standard adjustment can not structurally or physically be accommodated in the “nip” zone of cutter and vacuum drum, particularly if a large rotary blade drum is used. Therefore, it would be desirable to provide a regulation system for the counter-blade that is more easily accessible by the hand of an operator and that allows the same or an even higher level of accuracy with respect to the traditional system.

These objects are achieved by a cutting unit as defined in the appended claims whose definitions are integral part of the present description.

Further features and advantages of the present invention will be better understood from the description of preferred embodiments, which are given below by way of a non-limiting illustration, with reference to the following figures:

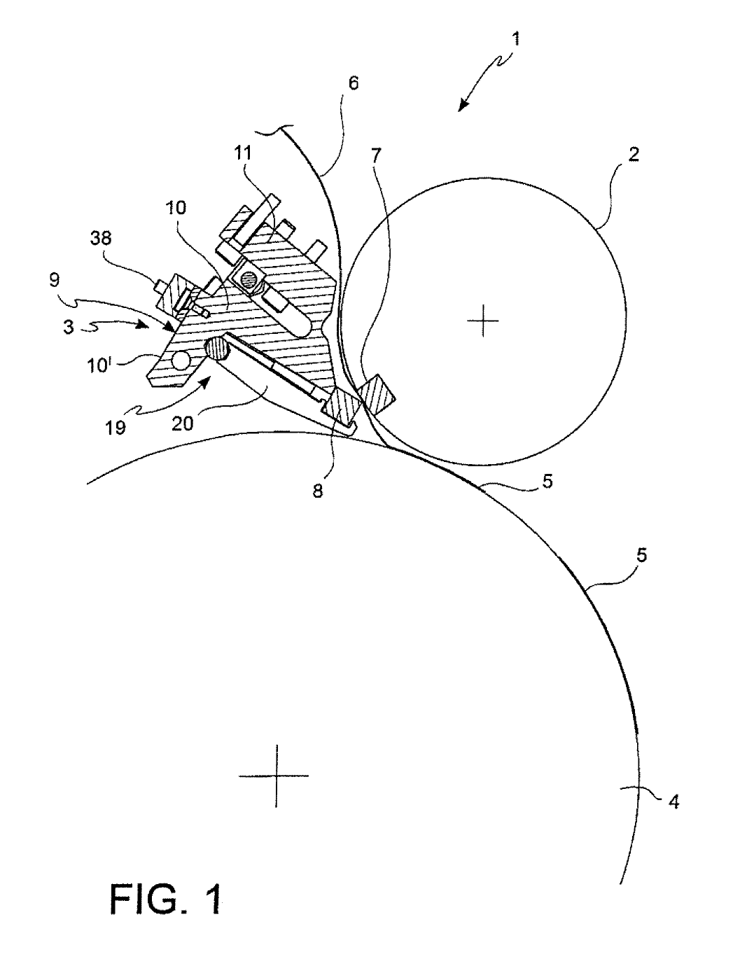

FIG. 1 shows a schematic top view of the arrangement of the inventive cutting unit and the vacuum drum;

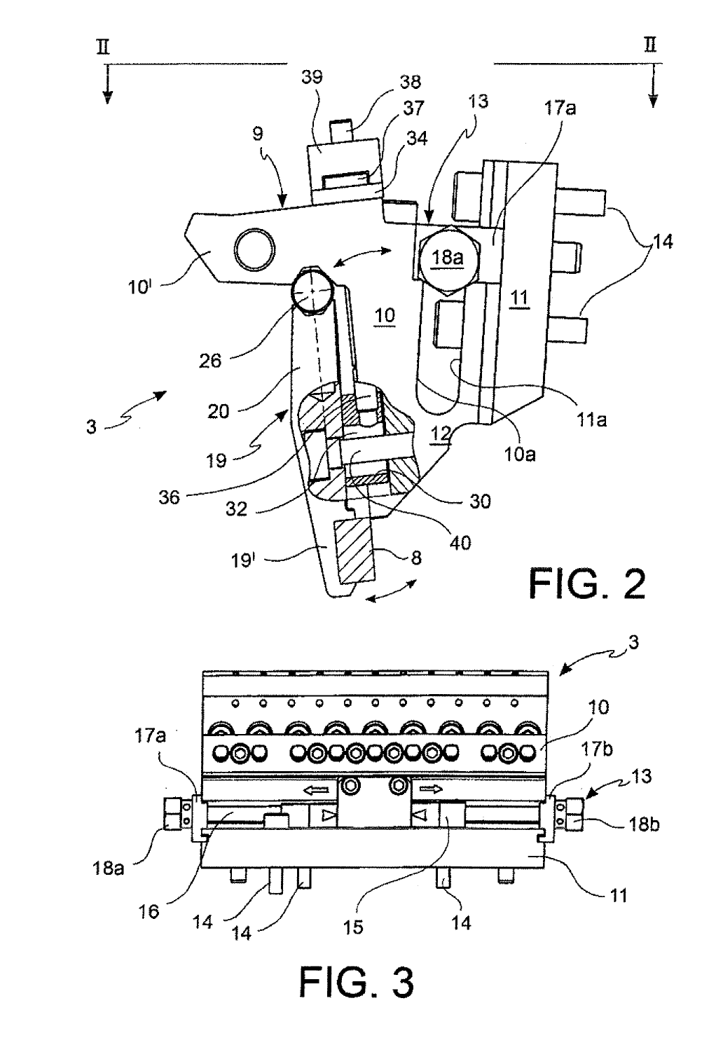

FIG. 2 shows a partially sectioned side view of the stationary blade assembly of the invention;

FIG. 3 shows a view of the assembly of FIG. 2, along the direction II-II;

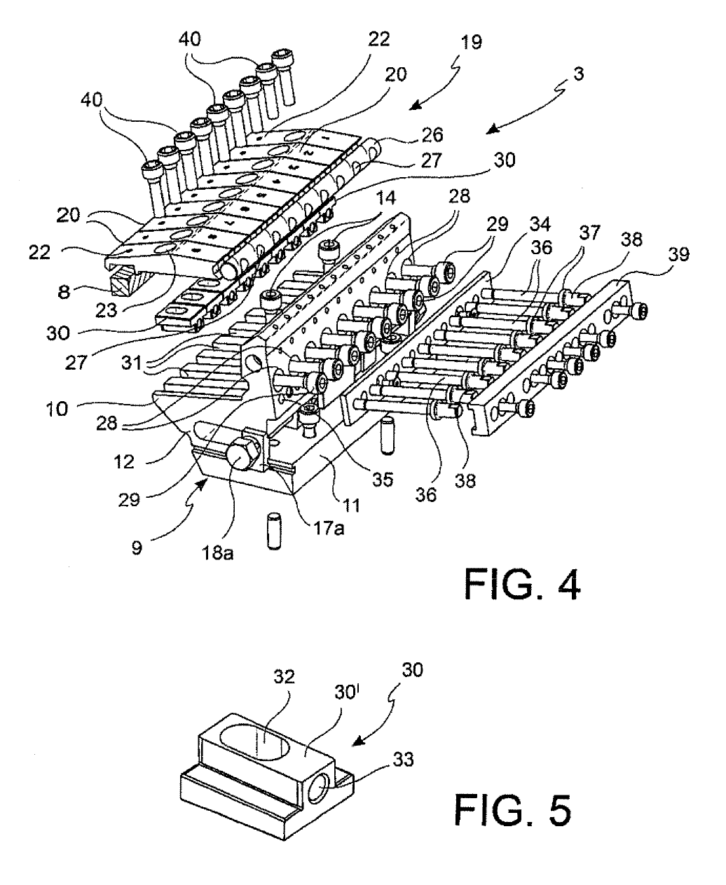

FIG. 4 shows an exploded perspective view of a particular of the assembly of FIG. 2;

FIG. 5 shows a perspective view of a particular of FIG. 4;

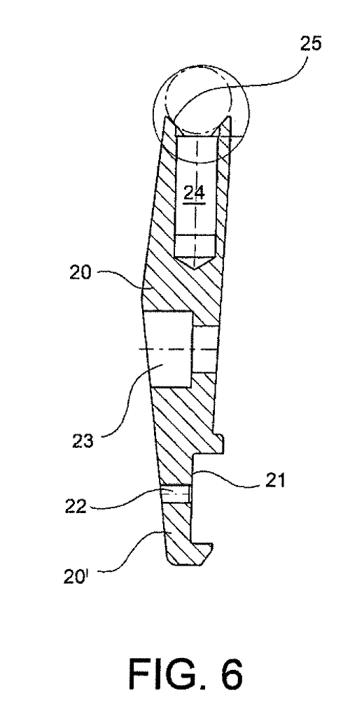

FIG. 6 shows a sectional side view of another particular of FIG. 4;

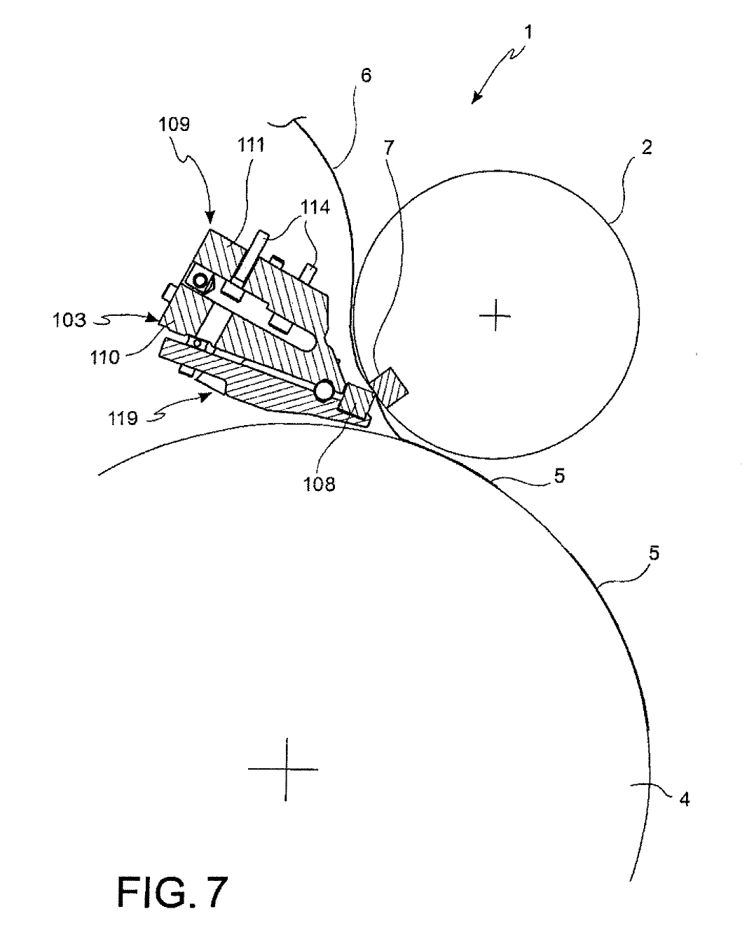

FIG. 7 shows a schematic top view of the arrangement of the inventive cutting unit and the vacuum drum, according to a different embodiment of the invention;

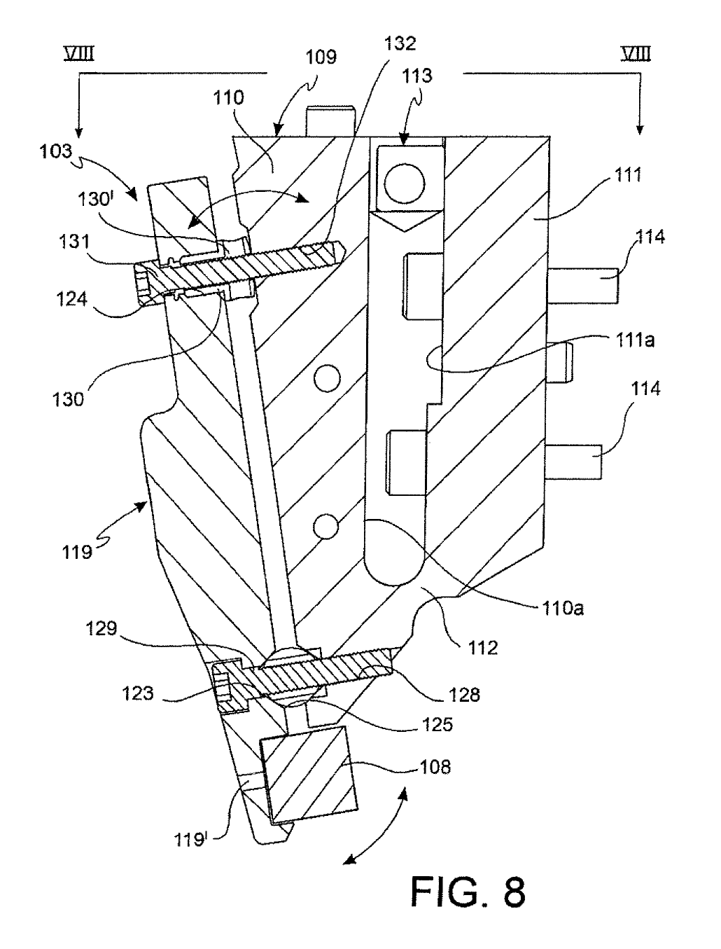

FIG. 8 shows a partially sectioned side view of the stationary blade assembly according to the embodiment of FIG. 1;

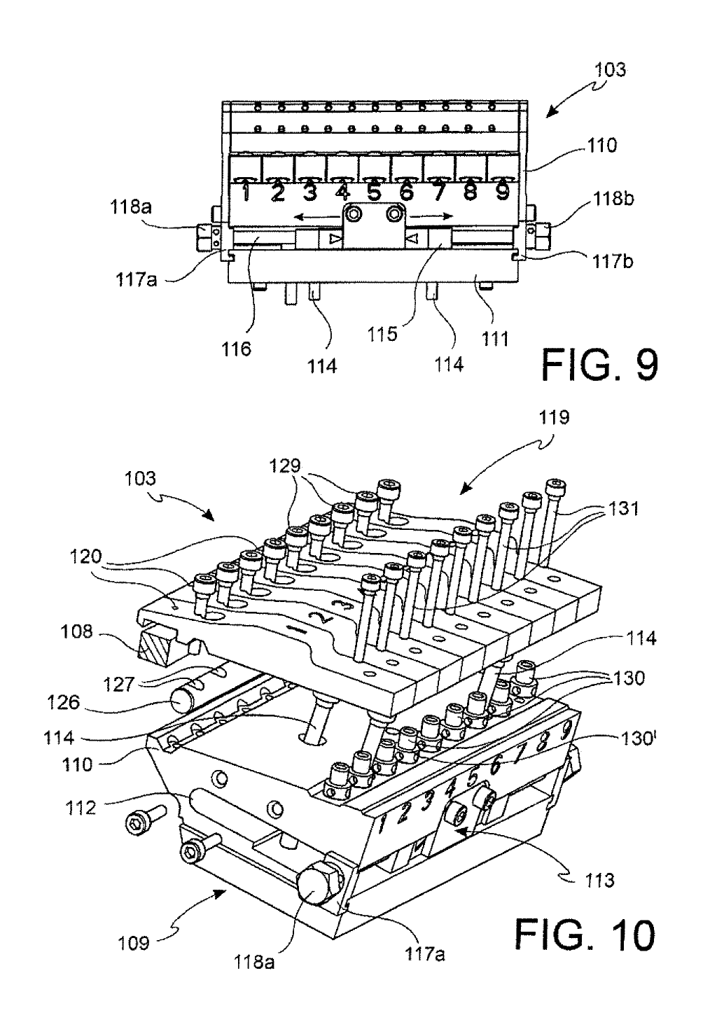

FIG. 9 shows a view of the assembly of FIG. 8, along the direction VIII-VIII;

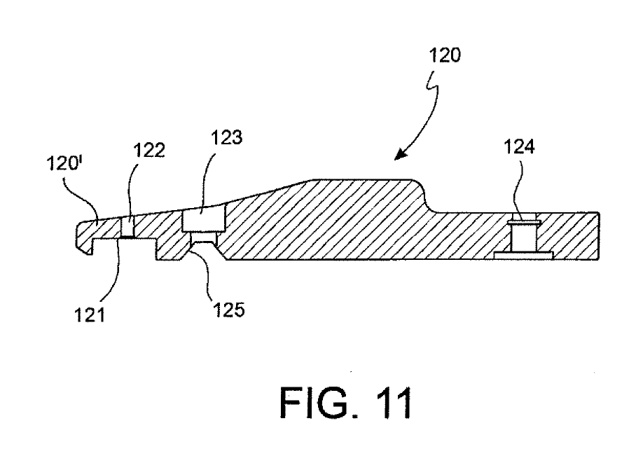

FIG. 10 shows an exploded perspective view of a particular of the assembly of FIG. 8;

FIG. 11 shows a sectional side view of another particular of FIG. 8.

With reference to the figures, the cutting unit, indicated as a whole with the numeral 1, comprises a rotary blade drum 2 and a stationary blade assembly 3, 103, and is positioned adjacent a vacuum drum 4 so that a label 5—that is cut from a label film 6—is retained for the most part of its length by the vacuum drum before the cut is made.

The rotary blade drum 2 in FIG. 1 is a conventional drum having one blade 7 at its periphery, but it may be a multiple-blade drum in other applications.

The stationary blade assembly 3 comprises a monolithic body 9, 109 that is substantially U-shaped, so that to present a first portion and a second portion —namely a movable portion 10, 110 and a fixed portion 11, 111—that face each other with substantially parallel surfaces 10a, 11a; 110a, 111a, and a linking portion 12, 112, so that a U-shaped groove is created therebetween. The fixed portion can be secured to the machine frame (not shown) by means of bolt-and-screw means 14, 114.

The linking portion 12, 112 has a reduced width, so that to allow the movable portion 10, 110 to be moved with respect to the fixed portion 11, 111 about a hinge axis that is contained in the linking portion 12, 112 (see arrow in FIGS. 2 and 8). The monolithic body 9, 109 is typically made of a material with a high coefficient of elasticity, such as stainless steel, so that an elastic deformation at portion 12, 112 occurs when the said movable portion 10, 110 is moved.

Suitable actuator means 13, 113 allow the displacement of the movable portion 10, 110 with respect to the fixed portion 11, 111. In some embodiments, as shown in FIGS. 3 and 9, the said actuator means 13, 113 comprise a wedge means 15, 115. The wedge means 15, 115 comprises a longitudinal threaded hole to which it is operatively associated an Archimedean screw 16, 116. The Archimedean screw 16, 116 is freely rotatable inside a couple of securing elements 17a, 17b; 117a, 117b that are fixed at the ends of the U-shaped groove and projects outwardly at both ends with bolt-shaped heads 18a, 18b; 118a, 118b that are accessible by an operator. By rotating the Archimedean screw 16, 116 clockwise or counter-clockwise, the wedge means 15, 115 can slide along the axis in the directions indicated by the arrows in FIGS. 3 and 9, respectively, in order to open or close (thanks to the resiliency of the piece) the U-shaped groove.

The system described above allows a thorough regulation of the distance between the bending and the fixed portions 10, 110 and 11, 111 of the monolithic body 9, 109 thanks to the said actuator means 13, 113. The function of this regulation will be apparent in the following description.

The movable portion 10, 110 of the monolithic body 9, 109 comprises an adjustable support 19, 119 for a bar-shaped blade 8, 108. This adjustable support 19, 119 protrude from the end of the movable portion 10, 110 that is proximal to the linking portion 12, 112 to form a projecting element 19′, 119′ having a finger-like section, to which the blade 8, 108 is removably fixed.

In this arrangement, as a general rule, the distance from the elastic zone to the blade edge is kept to a minimum and the distance between the elastic zone to the actuator wedge is kept to a maximum, in order to give maximum precision of adjustment.

In one embodiment, the distance between the cutting edge of the blade 8, 108 and the bottom of the U-shaped groove is between 2/4 and 1/1 or about ¾ or about ⅓ the distance between the bottom and the top end of the U-shaped groove.

The adjustable support 19, 119 can be integral with the monolithic body or can be a separate element.

In the embodiments shown in the exploded views of FIGS. 4 and 10, the said adjustable support 19, 119 is an assembly of several elements.

In the embodiment of FIGS. 2 to 4, the movable portion 10 of the monolithic body 9 is substantially L-shaped, so that an outwardly protruding shoulder 10′ is positioned at the distal end of the movable portion 10.

In the adjustable support 19, a plurality of finger elements 20 is provided, the said finger elements 20 being aligned side-by-side. Each finger element 20, as shown in FIG. 6, comprises, at its distal end 20′, a seat 21 to host a portion of the bar-shaped blade 8. When the adjustable support 19 is assembled, the aligned seats 21 form a groove wherein the blade 8 is housed. A through hole 22 is provided in the distal end 20′ of each finger element 20 wherein fixing screws (not shown) are inserted to secure the blade 8.

When the adjustable support 19 is assembled, the aligned distal ends 20′ of the finger elements 20 form the projecting element 19′ described above.

A second through hole 23 passes transversally the body of the finger element 20.

In addition, a blind hole 24 is longitudinally provided at the finger element end 25 proximal to the point of junction with the movable portion 10 of the monolithic body 9. This proximal end 25 has an arcuate profile section.

A substantially cylindrical bar 26 serves as a connecting element between the movable portion 10, in particular between the shoulder 10′ of the said movable portion 10, and the finger elements 20, in order to facilitate their assembly. The bar 26 has a plurality of transversal through holes 27 in alignment with the blind holes 24 of the finger elements 20.

The shoulder 10′ of the movable portion 10 has also a plurality of through holes aligned with the through holes 27 of the bar 26. The side of the shoulder 10′ that is designed to contact the bar 26 is appropriately shaped, such as with a convex profile, in order to accommodate the substantially cylindrical bar 26. It is evident that, if the said bar 26 has a different shape, such as a squared, elliptical, triangular or different section, both the contacting side of the shoulder 10′ and the proximal end 25 of the finger element 20 will be designed to match with the bar 26.

A plurality of screw means 29 is inserted in the through holes 28, 27 and the blind holes 24, to secure the finger elements 20 to the movable portion 10 and to give them sufficient rigidity to move integrally with the movable portion 10, when this latter is bent as explained above.

A plurality of actuator means 30, such as wedge means, one for each finger element 20, is also provided and is positioned between the said finger elements 20 and the surface of the movable portion 10 of the monolithic body 9 that faces the finger elements 20 in the assembly.

As clearly shown in FIG. 5, the actuator means 30 have a T-shaped profile, whose narrower section 30′ can be made to slide in respective grooves 31 provided side-by-side on the corresponding surface of the movable portion 10, longitudinally with respect to the axis of the finger elements 20. These grooves 31 have the function of guiding seats for the actuator means 30.

The actuator means 30 have a slot-shaped through hole 32 that passes transversally the body thereof and a longitudinal threaded hole 33 housed in the narrower section 30′, on the side that faces the shoulder 10′.

Tightening screws 40 are inserted in the through holes 23 of the finger elements 20, through the slot-shaped holes 32 of the actuator means 30 and in corresponding holes in the bottom of the grooves 31, in order to tighten the assembly finger element 20-actuator means 30-movable portion 10 with a preset tightening torque.

At least one of the surfaces of the actuator means 30 that contact the finger elements and/or the grooves 31 bottom is slightly inclined. Concomitantly, the corresponding surface of the finger elements 20 and/or of the grooves 31 is inclined of the same extent. In such a way, when each of the actuator means 30 slides along the grooves 31 axis, the distance between the movable portion 10 and the single finger element 20 is slightly varied. As the screw means 29 are made of a material having an high coefficient of elasticity, such as stainless steel, the movement of the finger elements is made through the elastic bending of the screw means 29, with a mechanism that is analogous to the one described above for the bending of the movable portion 10 of the monolithic body 9.

The movement of the actuator means 30 is caused by a plurality of actuating screws 36, one for each actuator means 30. These actuating screws 36 are inserted in corresponding through holes 35 in the movable portion 10, namely in the shoulder 10′ thereof, and then are operatively engaged in the longitudinal threaded holes 33 of the actuator means 30.

The outwardly projecting operating head 38 of the actuating screws 36 has a circular shoulder 37. A perforated plate 34 is sandwiched between the said circular shoulder 37 and the corresponding surface of the shoulder 10′ of the movable portion 10. The assembly is completed with a top plate 39 having a C-shaped section, which is screwed to the movable portion 10 in order keep the actuating screws 36 in position. In practice, the circular shoulder 37 of the actuating screw 36 operating head 38 is housed in the space between the perforated plate 34 and the top plate 39 and is longitudinally hold in the position, but is free to rotate, so that to function as an Archimedean screw. As the actuating screws 36 are rotated clockwise or counter-clockwise, the corresponding actuator means 30 is made to slide along the corresponding groove 31, so that to distance the finger element 20 from the movable portion 10 as described above.

As each of the finger elements 20 can be singularly adjusted as explained above by means of the corresponding actuator means 30, the cutting edge of the blade 8 can be regulated along its entire length, to correct any defect or irregularity and conform to the required cut contact profile.

In addition, the operating head 38 of the actuating screws 36 projects from the distal end of the stationary blade assembly 3 with respect to the blade 8, thus in a position that is far away the most encumbered area of the cutting unit. This structure allows insertion of the static blade into the “nip” of the cutter roller and the vacuum drum.

Conversely, by operating the actuator means 13 associated to the U-shaped groove of the monolithic body 9, thus bending the movable portion 10 thereof, a rotation along the arrows of FIG. 2 occurs. The blade 8 is also rotated as indicated by the corresponding arrows and this allows to finely regulate the distance between the stationary blade 8 and the rotary blade 7 or, in other words, to adjust the proximity of the stationary blade to the rotary blade uniformly along its entire length.

In the embodiment of FIGS. 8 to 10, the movable portion 110 of the monolithic body 109 is associated with an adjustable support 119.

In the adjustable support 119, a plurality of finger elements 120 is provided, the said finger elements 120 being aligned side-by-side. Each finger element 120, as shown in FIG. 11, comprises, at its distal end 120′, a seat 121 to host a portion of the bar-shaped blade 108. When the adjustable support 119 is assembled, the aligned seats 121 form a groove wherein the blade 108 is housed. A through hole 122 is provided in the distal end 120′ of each finger element 120 wherein fixing screws (not shown) are inserted to secure the blade 108.

When the adjustable support 119 is assembled, the aligned distal ends 120′ of the finger elements 120 form the projecting element 119′ described above.

A second and a third through holes 123, 124 pass transversally the body of the finger element 120. The said second through hole 123 is positioned close to the distal end 120′ of the finger element 120, substantially adjacent to the seat 121 for the blade 108. The third through hole 124 is instead positioned close to the opposite end of the finger element 120. The third through hole 124 is internally threaded.

The surface of the finger element 120, on the side wherein the seat 121 is positioned, has a concave profile 125 in correspondence with the said second through hole 123. When all the finger elements 120 are assembled side by side (as in FIG. 10), a semi-cylindrical groove is formed adjacent to and substantially parallel to the groove formed by the aligned seats 121.

A substantially cylindrical bar 126 serves as a connecting and hinging element between the movable portion 110 and the finger elements 120. The bar 126 is housed in the semi-cylindrical groove formed by the aligned concave profiles 125 of the finger elements 120 and has a plurality of transversal through holes 127 in alignment with the second through holes 123 of the finger elements 120.

The surface of the movable portion 110 has also a plurality of through holes 128 aligned with the through holes 127 of the bar 126. The portion of this surface that is designed to contact the bar 126 is also appropriately shaped, such as with a concave profile, in order to accommodate the substantially cylindrical bar 126. It is evident that, if the said bar 126 has a different shape, such as a squared, elliptical, triangular or different section, both the contacting side of the movable portion 110 and the concave profile 125 of the finger element 120 will be designed to match with the bar 126 shape.

A plurality of screw means 129 is inserted in the through holes 123, 127, 128, respectively, to secure the finger elements 120 to the movable portion 110 and to give them sufficient rigidity to move integrally with the movable portion 110, when this latter is bent as explained above. At the same time, the bar 126 functions as a pivoting axis for the finger elements 120 associated thereto, as it will be apparent below.

A plurality of actuator means 130, one for each finger element 120, is also provided. In the embodiment of FIGS. 8 to 10, the actuator means 130 takes the form of a bush 130 that is externally threaded in order to be screwed in the third through hole 124 of the finger element 120. The bush 130 comprises a shoulder 130′ that is designed to act against the surface of the moving portion 110, so that, when the bush 130 is screwed into the through hole 124, the distance between the corresponding finger element 120 and the moving portion 110 of the monolithic body 109 is shortened. On the contrary, when the bush 130 is unscrewed, the distance between the corresponding finger element 120 and the moving portion 110 of the monolithic body 109 is lengthened. In so doing, each finger element 120 rotates around the pivoting axis of the bar 126. It should be noted that, even if such a rotation is contrasted by the rigidity given by the screw means 129, the said regulation can be performed due to the elasticity of the material of which the said screw means 129 are made, typically stainless steel, that allows it to elastically bend to an extent sufficient for the fine regulation of the finger elements 120. This is the same mechanism on which the bending of the moving portion 110 around the portion 112 is based.

The bushes 130 are pierced, in order to allow tightening means 131 to pass therethrough without substantial interference. The said tightening means 131 are typically screws that are then screwed into corresponding threaded blind holes 132 positioned in the moving portion 110 of the monolithic body 109, in alignment with the third through hole 124 of each finger element 120. In such a way, after each bush 130 has been regulated, the system is tightened with a preset tightening torque to give it sufficient rigidity.

The surface of the moving portion 110 that surrounds the threaded blind holes 132 is sunken to accommodate the shoulder 130′ of the corresponding bush 130.

As each of the finger elements 120 can be singularly adjusted as explained above by means of the corresponding actuator means 130, the cutting edge of the blade 108 can be regulated along its entire length, to correct any defect or irregularity and conform to the required cut contact profile.

In addition, the actuator means 130 are positioned far away the most encumbered area of the cutting unit. This structure allows insertion of the static blade into the “nip” of the cutter roller and the vacuum drum and at the same time regulating the actuator means 130 without disassembling the stationary blade assembly 103.

Conversely, by operating the actuator means 113 associated to the U-shaped groove of the monolithic body 109, thus bending the movable portion 110 thereof, a rotation along the arrows of FIG. 8 occurs. The blade 108 is also rotated as indicated by the corresponding arrows and this allows to finely regulate the distance between the stationary blade 108 and the rotary blade 7 or, in other words, to adjust the proximity of the stationary blade to the rotary blade uniformly along its entire length.

The embodiment of FIGS. 8-10, with respect to the previously described embodiment, is characterised by an improved constructional simplicity, as it is made of a smaller number of parts. Moreover, the positioning of the pivoting axis very close to the projecting element 119′ allows a finer regulation of the blade 108 cutting edge.

From what is described above, it appears that a further object of the invention is a stationary blade assembly 3 for a cutting unit 1 in labelling machines, comprising an adjustable support 19 for a bar-like blade 8, wherein the said adjustable support 19 provides for the punctual regulation of said bar-like blade 8 along its length with respect to irregularities or defects of its cutting edge, wherein a plurality of actuator means 30 are provided for the adjustment of said adjustable support 19, characterised in that the said actuator means 30 are remotely operated.

A further object of the invention is a stationary blade assembly 103 for a cutting unit 1 in labelling machines, comprising an adjustable support 119 for a bar-like blade 108, wherein the said adjustable support 119 provides for the punctual regulation of said bar-like blade 108 along its length with respect to irregularities or defects of its cutting edge, wherein a plurality of actuator means 130 are provided for the adjustment of said adjustable support 119, characterised in that the said actuator means 130 are adjacent to the distal end of the moving portion 110 of the monolithic body 109 with respect to the linking portion 112 thereof, and in that the pivoting axis of said adjustable support 119 is adjacent to the projecting element 119′ thereof.

Irregularities and defects will destroy the cutting process. The present device can effectively re-profile the cutting edge to match the rotary blade edge profile. This device may be applied even at different cutting units, for example to the ones that do not mount a monolithic support as described below, but a more complex mechanism of regulation of the distance between the counter-blade and the blade.

It will be appreciated that only particular embodiments of the present invention have been described herein, to which those skilled in the art will be able to make any and all modifications necessary for its adjustment to specific applications, without however departing from the scope of protection of the present invention as defined in the annexed claims.

1-28. (canceled)

29. A cutting unit for cutting labels from a label film in labelling machines, comprising
a rotary blade drum and
a stationary blade assembly, the said stationary blade assembly comprising a substantially U-shaped monolithic body having a movable portion, and a fixed portion facing said movable portion and linked thereto by a linking portion forming a U-shaped groove therebetween,
wherein the movable portion of the monolithic body comprises an adjustable support for a blade, protruding from the end of the movable portion, that is proximal to the linking portion, a projecting element defined by said adjustable support, the said blade being connected to said projecting element.

30. The cutting unit of claim 29, wherein the distance between the cutting edge of the blade and the bottom of the U-shaped groove is from about 50% to about 100% of the distance between the bottom and the top end of the U-shaped groove.

31. The cutting unit of claim 29, wherein the adjustable support is integral with the monolithic body.

32. The cutting unit of claim 29, wherein the adjustable support is a separate element from the monolithic body.

33. The cutting unit of claim 29, wherein the adjustable support comprises a plurality of finger elements, the said finger elements being aligned side-by-side, wherein each finger element comprises, at its distal end, a seat to host a portion of the blade so that, when the adjustable support is assembled, the aligned seats form a groove wherein the blade is housed and the aligned distal ends of the finger elements form the said projecting element.

34. The cutting unit of claim 29, wherein the movable portion of the monolithic body is substantially L-shaped, so that an outwardly protruding shoulder is positioned at the distal end of the movable portion.

35. The cutting unit of claim 33, wherein each of the finger elements has a blind hole that is longitudinally provided at its end proximal to the point of junction with the movable portion of the monolithic body, a plurality of screw means passing through the said movable portion being inserted in said blind holes, to secure the finger elements to the movable portion and to give them sufficient rigidity to move integrally with the movable portion.

36. The cutting unit of claim 35, wherein the screw means comprise material having a high coefficient of elasticity.

37. The cutting unit of claim 33, wherein a plurality of actuator means, one for each finger element, is provided between the finger elements and the surface of the movable portion of the monolithic body that faces the finger elements.

38. The cutting unit of claim 37, wherein the actuator means have a T-shaped profile having a narrower section that is adapted for sliding in respective grooves provided side-by-side on the corresponding surface of the movable portion, longitudinally with respect to the axis of the finger elements.

39. The cutting unit of claim 37, wherein the actuator means comprise a slot-shaped through hole that passes transversally through the body thereof, tightening screws passing through the finger elements and the slot-shaped hole of the actuator means is engaged in corresponding holes in the bottom of the grooves, in order to tighten the assembly finger element -actuator means-movable portion.

40. The cutting unit of claim 39, wherein the assembly finger element -actuator means-movable portion is subjected to a preset tightening torque.

41. The cutting unit of claim 37, wherein at least one of the surfaces of the actuator means that contact the finger elements and/or the grooves bottom is slightly inclined.

42. The cutting unit of claim 37, wherein the actuator means are provided with a longitudinal threaded hole housed in a narrower section, on a side that faces the shoulder, a plurality of actuating screws, one for each actuator means, being inserted in corresponding through holes in the movable portion and being operatively engaged in the said longitudinal threaded holes of the actuator means, so that, as the actuating screws are rotated clockwise or counter-clockwise, the corresponding actuator means is made to slide along the corresponding groove, to cause the corresponding finger element to bend and to distance from the movable portion.

43. The cutting unit of claim 42, wherein the actuating screws comprise a head projecting from the distal end of the stationary blade assembly with respect to the blade.

44. The cutting unit of claim 33, wherein the finger element comprises a second and a third through hole passing transversally through the body of the finger element, wherein the second through hole is positioned close to the distal end of the finger element, substantially adjacent to the seat for the blade; and the third through hole is positioned close to the opposite end of the finger element, the third through hole being internally threaded.

45. The cutting unit of claim 44, wherein the surface of the finger element, on the side wherein the seat is positioned, has a concave profile corresponding to the said second through hole, so that, when all of the finger elements are assembled side-by-side, a semi-cylindrical groove is formed adjacent to and substantially parallel to the groove formed by the aligned seats.

46. The cutting unit of claim 45, wherein a substantially cylindrical bar is provided as a connecting and hinging element between the movable portion and the finger elements, the bar being housed in the semi-cylindrical groove formed by the aligned concave profiles of the finger elements and having a plurality of transversal through holes in alignment with the said second through holes of the finger elements.

47. The cutting unit of claim 46, wherein the surface of the movable portion comprises a plurality of through holes aligned with the through holes of the bar and wherein the portion of the surface that is designed to contact the bar is so shaped as to accommodate the substantially cylindrical bar.

48. The cutting unit of claim 47, wherein a plurality of screw means are inserted in the through holes to secure the finger elements to the movable portion and to give them sufficient rigidity to move integrally with the movable portion, when the movable portion is bent.

49. The cutting unit of claim 44 comprising a plurality of actuator means, one for each finger element, each actuator means being in the form of a bush that is externally threaded in order to be screwed into the third through hole of the finger element, the said bush comprising a shoulder that is designed to act against the surface of the moving portion, so that, when the bush is screwed into the third through hole, the distance between the corresponding finger element and the moving portion of the monolithic body is shortened.

50. The cutting unit of claim 49, wherein the bushes are pierced, in order to allow tightening means to pass therethrough without substantial interference and to engage into corresponding threaded blind holes positioned in the moving portion of the monolithic body, in alignment with the third through hole of each finger element.

51. The cutting unit of claim 29, wherein the monolithic body comprises a material having a high coefficient of elasticity.

52. The cutting unit of claim 29, wherein the movable portion is bent with respect to said fixed portion by operating actuator means.

53. A stationary blade assembly for a cutting unit in labelling machines, comprising an adjustable support for a bar-like blade, wherein the adjustable support provides for the punctual regulation of said bar-like blade along its length with respect to irregularities or defects of its cutting edge, wherein a plurality of actuator means are provided for the adjustment of adjustable support, and wherein the actuator means are remotely operated.

54. The stationary blade assembly of claim 53, wherein the operation of said actuator means is made by actuating screws having operating heads which are positioned in the stationary blade assembly opposite to the end where the blade is mounted.

55. The stationary blade assembly of claim 53, wherein the said adjustable support comprises a plurality of finger means holding the bar-like blade, each of said finger means being adjustable by the actuator means.

56. A stationary blade assembly for a cutting unit in labelling machines, comprising an adjustable support for a bar-like blade, wherein the said adjustable support provides for the punctual regulation of said bar-like blade along its length with respect to irregularities or defects of its cutting edge, wherein a plurality of actuator means are provided for the adjustment of said adjustable support, characterised in that the said actuator means are adjacent to the distal end of the moving portion of the monolithic body with respect to the linking portion thereof, and in that the pivoting axis of said adjustable support is adjacent to the projecting element thereof.
